(19) United States
(12) Patent Application Publication
(10) Pub. No.: US 2004/0226585 A1
(43) Pub. Date: Nov. 18, 2004

(54) Cleaning systems with monitoring functions

(75) Inventors: Michael Tang, Hsinchu (TW); Chih-Chin Tsai, Hsinchu (TW); Wen-Tay Wu, Hsinchu (TW); Jia-Lih Shyu, Hsinchu (TW)

Correspondence Address: Finnegan, Henderson, Farabow, Garrett & Dunner, L.L.P., 1300 I Street, N.W., Washington, DC, 20005-3315, US

(73) Assignee: Macronix International Co., Ltd.

(21) Appl. No.: 10/439,014

(22) Filed: May 16, 2003

(51) Int. Cl. B08B 3/02

(52) U.S. Cl. 134/56 R; 134/58 R; 134/113; 134/198; 134/95.3; 134/103.2

(57) ABSTRACT

A cleaning system that includes a cleaning device, a pipeline having a first end, a valve connected between the cleaning device and a second end of the pipeline to enable water flow from the pipeline to the cleaning device when the valve is held at an open position, a limit switch connected to the valve for providing a signal in response to a position of the valve, a controller electrically coupled to the limit switch to receive the signal, and a monitor electrically connected to the controller and operating in response to the signal.

DESCRIPTION OF THE INVENTION

1. Field of the Invention

This invention relates in general to a cleaning system and, more particularly, to a clean system with a monitoring function.

2. Background of the Invention

In the semiconductor industry, fabrication of a semiconductor device requires several tens or hundreds of processing steps, including diffusing, etching, thin film depositing, ion implanting, and photolithography. Most of the processes use chemicals that are harmful to humans if direct contact is made. For example, acids and other toxic materials in gaseous or liquid form may attack human eyes or skins. Therefore, a cleaning center is often provided near a fabrication site in a semiconductor manufacturing facility, or a fab, to allow a semiconductor fab operator to remove harmful chemicals with which the operator may have accidently come into contact.

A cleaning center generally includes a cleaning system that provides, among others, water for a fab operator to remove or dilute harmful chemicals. However, conventional cleaning systems may simply function to provide water without a monitoring mechanism. As a result, an affected person may not be attended to or given help in time. Besides, the cleaning systems are provided for emergency use only and are otherwise idle for a long period of time. As a result, stagnant water contained in the pipelines of the cleaning systems may eventually become contaminated or give off an odor, and thus may be unacceptable for its intended purpose.

### SUMMARY OF THE INVENTION

Accordingly, the present invention is directed to a cleaning system that obviates one or more of the problems due to limitations and disadvantages of the related art.

To achieve these and other advantages, and in accordance with the purpose of the invention as embodied and broadly described, there is provided a cleaning system that includes a cleaning device, a pipeline having a first end, a valve connected between the cleaning device and a second end of the pipeline to enable water flow from the pipeline to the cleaning device when the valve is held at an open position, a limit switch connected to the valve for providing a signal in response to a position of the valve, a controller electrically coupled to the limit switch to receive the signal, and a monitor electrically connected to the controller and operating in response to the signal.

In one aspect, the cleaning device includes an eye wash.

In another aspect, the cleaning device includes a shower head.

Also in accordance with the present invention, there is provided a cleaning system that includes at least one cleaning device, at least one valve connected to a corresponding one of the at least one cleaning device, a pipeline having a first end connected to the at least one cleaning device capable of providing water to the at least one cleaning device when the at least one valve is held at an open position, at least one limit switch connected to a corresponding one of the at least one valve for providing a signal in response to a position of the at least one valve, and a controller electrically connected to the at least one limit switch for receiving the signal.

Still in accordance with the present invention, there is provided a cleaning system that includes a cleaning device, a water source, a pipeline connected to the water source, a first valve connected between the cleaning device and the pipeline to deliver water from the water source to the cleaning device when the first valve is held at an open position, and discontinue delivery of water when the first valve is held at a closed position, a limit switch connected to the first valve for providing a signal in response to one of the positions of the valve, and a controller electrically connected to the limit switch for receiving the signal and providing a notification of the cleaning device being in use.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute part of this specification, illustrate several embodiments of the invention and together with the description, serve to explain the principles of the invention.

### BRIEF DESCRIPTION OF THE DRAWINGS

FIG. 1 is a block diagram of a cleaning system in accordance with one embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

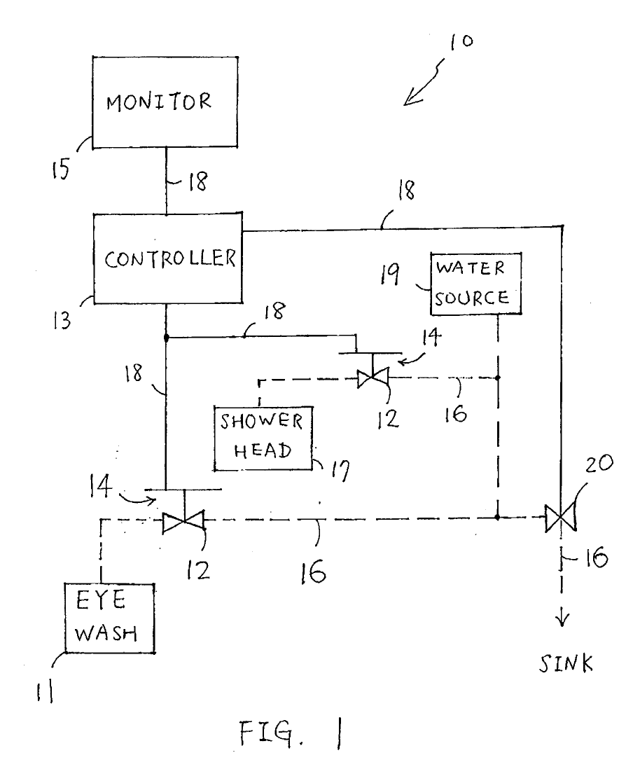

FIG. 1 is a block diagram of a cleaning system 10 in accordance with one embodiment of the present invention. Referring to FIG. 1, cleaning system 10 includes at least one cleaning device (not numbered) having at least one valve 12, at least one limit switch 14, a controller 13 and a monitor 15. In one embodiment, the at least one cleaning device includes an eye wash 11 or a shower head 17. Each of the at least one valve 12 is connected between a corresponding one of the at least one cleaning device and a water source 19 through pipelines 16 (represented in the form of dashed lines). Each of the at least one limit switch 14 is electrically connected to a corresponding one of the at least one valve 12. Monitor 15, controller 13, valve 12 and limit switch 14 are electrically connected through electrical lines 18 (represented in the form of solid lines).

Limit switch 14 may be a device that functions to connect or disconnect circuits according to the operating position of corresponding valve 12. For example, when valve 12 is in an “open” position, limit switch 14 is activated to electrically connect electrical lines 18 between valve 12 and controller 13. In contrast, when valve 12 is in a “closed” position, limit switch 14 electrically disconnects electrical lines 18 between valve 12 and controller 13.

In operation, a person that has come into contact with acids or toxic materials could use shower head 17 or eye wash 11 to clean the affected portions of his or her body. The person would activate valve 12 with a pull handle/chain (not shown) or a foot switch (not shown). Valve 12 is held at an open position to allow water to flow from water source 19 through pipelines 16 to the cleaning device chosen for use. Corresponding limit switch 14 of valve 12 then provides a signal to controller 13 to indicate that a cleaning device is at use. Controller 13, in turn, sends the signal to monitor 15 such that a remote operator at the monitor side is advised of the emergency and that a person may be in need of assistance.

Cleaning system 10 may also include a valve 20 different from valve 12. In one embodiment, valve 12 includes an on/off valve, and valve 20 includes a solenoid valve. Valve 20 is electrically connected to controller 13 through electrical lines 18, and connected between water source 19 and a sink (not numbered) through pipelines 16. Valve 20 is activated at a predetermined time to conduct water from water source 19 to the sink to keep refresh the water contained in pipelines 16. In one embodiment, valve 20 is manually activated or deactivated by an operator. In another embodiment, controller 13 includes a programmable logic controller (“PLC”) and automatically activates valve 20. An operator of cleaning system 10 is permitted to determine the frequency for the automatic pipeline refreshing, or cleaning. The operator may further determine the length of time for each pipeline cleaning. In one embodiment, a weekly cleaning is performed at three-minute intervals.

In a manual cleaning process, the operator would manually activate valve 20 to drain the water in pipelines 16 at a predetermined duration, and then deactivate valve 20 to complete the cleaning process. For automatic cleaning, the cleaning frequency and interval are programmed into controller 13. Controller 13 then performs the task of cleaning the pipes at the predetermined interval by activating valve 20 for the predetermined duration, and deactivates valve 20 at the end of the predetermined duration.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cleaning system, comprising:
a cleaning device;
a pipeline having a first end;
a valve connected between the cleaning device and a second end of the pipeline to enable water flow from the pipeline to the cleaning device when the valve is held at an open position;
a limit switch connected to the valve for providing a signal in response to a position of the valve;
a controller electrically coupled to the limit switch to receive the signal; and
a monitor electrically connected to the controller and operating in response to the signal.

2. The system of claim 1, wherein the cleaning device includes an eye wash.

3. The system of claim 1, wherein the cleaning device includes a shower head.

4. The system of claim 1, wherein the valve includes an on/off valve.

5. The system of claim 1, further comprising a first valve electrically connected to the controller.

6. The system of claim 5, wherein the first valve includes a solenoid valve.

7. The system of claim 5, wherein the first valve is connected between a water source and a sink, and is controlled by the controller to allow water from the water source to flow to the sink through the pipeline at a predetermined frequency.

8. The system of claim 5, wherein the first valve is connected between a water source and a sink, and is controlled by the controller to allow water from the water source to flow to the sink through the pipeline at a predetermined duration.

9. A cleaning system, comprising:
at least one cleaning device;
at least one valve connected to a corresponding one of the at least one cleaning device;
a pipeline having a first end connected to the at least one cleaning device capable of providing water to the at least one cleaning device when the at least one valve is held at an open position;
at least one limit switch connected to a corresponding one of the at least one valve for providing a signal in response to a position of the at least one valve; and
a controller electrically connected to the at least one limit switch for receiving the signal.

10. The system of claim 9, further comprising at least one monitor electrically connected to the controller.

11. The system of claim 9, wherein the at least one valve includes an on/off valve.

12. The system of claim 9, further comprising a first valve electrically connected to the controller.

13. The system of claim 12, wherein the first valve includes a solenoid valve.

14. The system of claim 12, wherein the first valve is controlled by the controller.

15. A cleaning system, comprising:
a cleaning device;
a water source;
a pipeline connected to the water source;
a first valve connected between the cleaning device and the pipeline to deliver water from the water source to the cleaning device when the first valve is held at an open position, and discontinue delivery of water when the first valve is held at a closed position;
a limit switch connected to the first valve for providing a signal in response to one of the positions of the valve; and
a controller electrically connected to the limit switch for receiving the signal and providing a notification of the cleaning device being in use.

16. The system of claim 15, further comprising a monitor electrically connected to the controller and operates in response to the signal

17. The system of claim 15, further comprising a second valve electrically connected to the controller and connected between the water source and a sink for providing water from the water source to flow to the sink.

18. The system of claim 17, wherein the second valve is controlled by the controller such that water flows to the sink at a predetermined frequency.

19. The system of claim 17, wherein the second valve is controlled by the controller such that water flows to the sink at a predetermined duration.
